(19) United States
(12) Patent Application Publication
(10) Pub. No.: US 2007/0209435 A1
(43) Pub. Date: Sep. 13, 2007

(54) MONITORING THE TIME OF OPERATING OF A DEVICE

(75) Inventor: Georg Sauerlaender, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,720

(22) PCT Filed: Sep. 19, 2005
(86) PCT No.: PCT/IB05/53065

§ 371 Date: Mar. 21, 2007

(30) Foreign Application Priority Data
Sep. 23, 2004 (EP) 04104631.9

(51) Int. Cl. G07C 3/04; G01P 1/12

(52) U.S. Cl. 73/432.1

(57) ABSTRACT

An occurrence of an operation of a device (1) is detected by a sensor (6). The operation itself, or its true occurrence, is detected, not a command to activate the operation. The time of said occurrence is measured, accumulated and, on demand, represented. Said occurrence can be sensed from any part of the device (1) of which a property changes upon the occurrence of said operation.

### FIELD OF THE INVENTION

The invention relates to a method, an apparatus and a system for monitoring a time of operation of a device as described in the preambles of claims 1, 15 and 18 respectively.

### BACKGROUND OF THE INVENTION

U.S. Pat. No. 6,307,332 discloses a lamp life meter. The lamp is arranged in a housing, such as of an endoscope light source unit, a copying machine and a projector. The housing contains a control circuit to switch the lamp on or off. The housing has a socket which is suitable to plug into it a lifetime measurement and monitoring module. Said module contains a battery to supply other components contained in the module, such as a processor and a memory. When plugged into said socket, the module is connected to the control circuit inside the lamp housing. When the lamp is switched on the module receives a signal from the control circuit indicating that the lamp has been turned on.

According to said prior art, the hardware of a device which state is to be monitored should be adapted to receive a measuring module and to provide some signal to the module indicating said state. Such adaptation will increase the costs of manufacturing and therefore of its use. In some cases, such as for medical equipment, it may even require additional safety certification. Adaptation may be more difficult to carry out with equipment which is already in use, in particular equipment which is fixedly installed and/or virtually permanent in use, such as pumps and emergency exit lights. In some cases it may even be physically impossible or too costly to carry out such adaptation.

Further, according to the prior art, there are cases where a human being cannot discern directly if a monitored operation of the device, which is monitored, is on or off. For example, the device may be located at a location which is far from the person or difficult to access. In cases alike one cannot be certain that a signal supplied to the module is indeed indicating the state of operation of a monitored part of the device, because said part or a different part of the device may be malfunctioning, such that the monitored part is not operating in spite of being indicated to the module as operating. As a result, a user cannot detect proper operation of the device as expected and the accumulated measured on times of said operation may contain a large uncertainty, which may make the application of such module useless under certain circumstances.

Because of the existence of a large uncertainty about the measured and accumulated on time of a monitored operation of a device it is equally uncertain when to maintain the device, possibly to replace some part of the device, dependent on said measured and accumulated time.

### OBJECT OF THE INVENTION

It is an object of the invention to solve the drawbacks of the prior art as described above.

### SUMMARY OF THE INVENTION

The above object of the invention is achieved by providing a method as described in claim 1.

Accordingly, the time which is measured will always be a true on time of the monitored operation of the device. By absence of uncertainty about the measured and accumulated on time of said operation, one may maintain the device more cost effectively. One may schedule maintenance better with a view on the true progress of the measured accumulated time with respect to a predetermined value before which maintenance must be carried out.

The above object of the invention is achieved also by providing an apparatus as described in claim 15.

The above object of the invention is achieved also by providing a system as described in claim 18.

### BRIEF DESCRIPTION OF THE DRAWINGS

The invention will become more gradually apparent from the following exemplary description in connection with the accompanying drawing. In the drawing:

FIG. 1 shows a diagram of an embodiment of an apparatus which uses the method according to the invention to operate;

FIG. 2 shows a diagram of a system of separate apparatuses which uses the method according to the invention to operate; and

FIG. 3 shows a diagram of another system of separate apparatuses which uses the method according to the invention to operate.

### DETAILED DESCRIPTION OF EXAMPLES

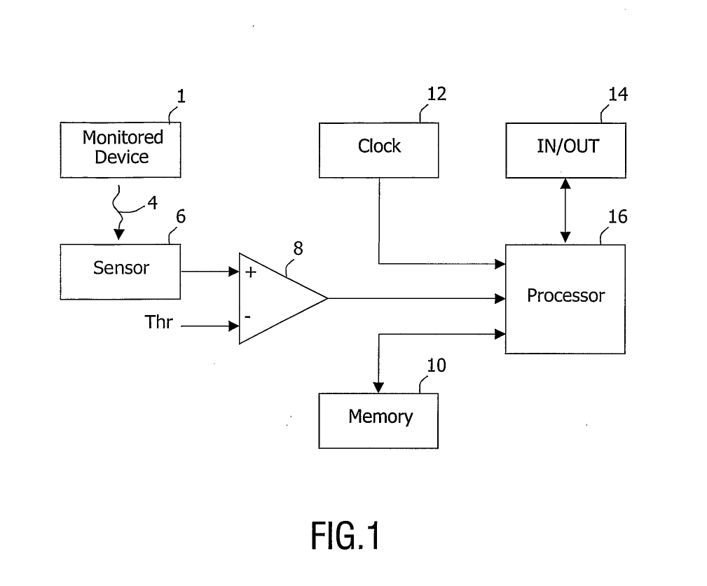

The apparatus according to the invention, shown in FIG. 1, is used to detect an operation of a device 1 being activated, to measure the duration of said operation being active, which is called on time here, to accumulate such measured on times and to represent the accumulated time to the outside.

The monitored device 1 can be very diverse, for example, a lighting device, a pump, gear box and transportation means.

The operation of which the occurrence or activity is monitored could be a state of being switched on of the device 1 as a whole or a part thereof. However, different kinds of events of the device as a whole or of a part thereof could be monitored, such as a property or amount of activity, for example an intensity of emitted light, an intensity of emitted heat, an intensity of vibration and a magnitude of a linear or rotational speed. In FIG. 1 such an activity, indicated by a wavy arrow 4, is detectable from the outside of the device 1 by a sensor 6. The sensor 6 is shown at a distance from the device 1. However, within the meaning of the invention this is not required. The sensor 6 may also be adhered in any way to the device 1 or to a part thereof. The same applies for the apparatus as a whole.

The apparatus according to the invention, shown in FIG. 1, comprises in addition to the sensor 6, a comparator 8, a memory 10, a clock generator 12, an input/output part 14 and a processor 16. The comparator 8, the memory 10, the clock generator 12 and the input/output part 14 are all connected to the processor 16.

The apparatus according to the invention, shown in FIG. 1, operates as follows.

When a monitored operation of the device 1 is active, this activity is sensed by sensor 6, which then supplies a detection signal to a non-inverting input of comparator 8. An inverting input of comparator 8 receives a threshold signal Thr, which represents a threshold value. If the amount of activity sensed by sensor 6, which is represented by its output, exceeds the threshold value the output of the comparator will flip, in particular from a first logical state to a second logical state. Then the processor 16 will start a counter for counting clock pulses provided by the clock generator 12. Upon a reverse transition of the output of comparator 8 the processor stops counting. The count value represents a value of the time during which the monitored operation was active. The processor 16 retrieves an accumulated measured time value from memory 10. The processor 16 adds the recently counted value to the value retrieved from memory 10 to provide an updated value for the accumulated measured time. Then, processor 16 replaces the accumulated measured time value in memory 10 by the updated accumulated measured time value.

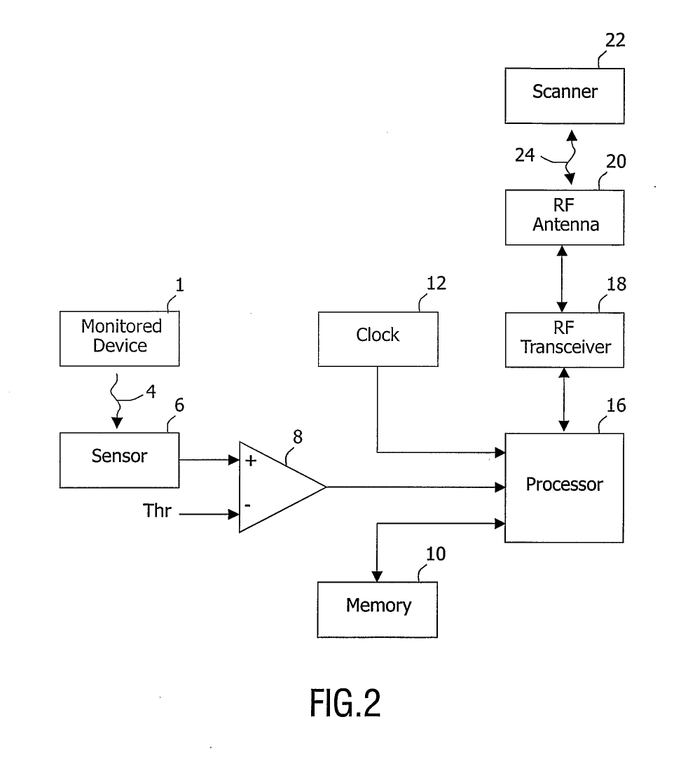

The accumulated measured time value can be retrieved also by a command from input/output part 14 and can then be supplied to the input/output part 14 for further processing, such as to be displayed. Said command may be generated at the input/output part 14, for example manually by pushing a button. Said command may also be received from an additional circuit or apparatus which is not shown in FIG. 1. The accumulated measured time value retrieved from memory 10 by such command can be supplied to said additional circuit or apparatus. FIG. 2 shows a diagram of an example of such a system comprising an additional apparatus for generating said command and, by that, for retrieving and receiving the accumulated measured time value from memory 10.

In the diagram of the explanatory system shown in FIG. 2 the input/output part 14 is replaced by an RF (radio frequency) transmitter 18, which is connected to the processor 16 and to a RF antenna 20. The apparatus shown in FIG. 2 and comprising parts 6 to 12 and 16 to 20 is called first or sensing apparatus here. Said additional apparatus is called second or monitoring apparatus here. In the embodiment shown in FIG. 2 the monitoring apparatus is a scanner 22, which comprises a RF transceiver and a RF antenna (both not shown) itself. The transceivers are tuned to each other for enabling transmission of said command and of said accumulated measured time value as indicated by double sided wavy arrow 24.

The system shown in FIG. 2 may be equipped such that the scanner 22 may selectively address different sensing apparatuses. This does not only allow to process accumulated measured time values obtained for different monitored devices in may ways independent from each other, but also with regard to each other. This enables scheduling of maintenance of groups of monitored device, such as groups of lighting devices in a factory hall. Different weights of significance may be used for different devices, such as dependent from their locations and safety conditions. This allows to schedule maintenance of the group of devices at the same, optimal time against minimum costs. This is made possible in the first place only because no uncertain accumulated measured time values are obtained.

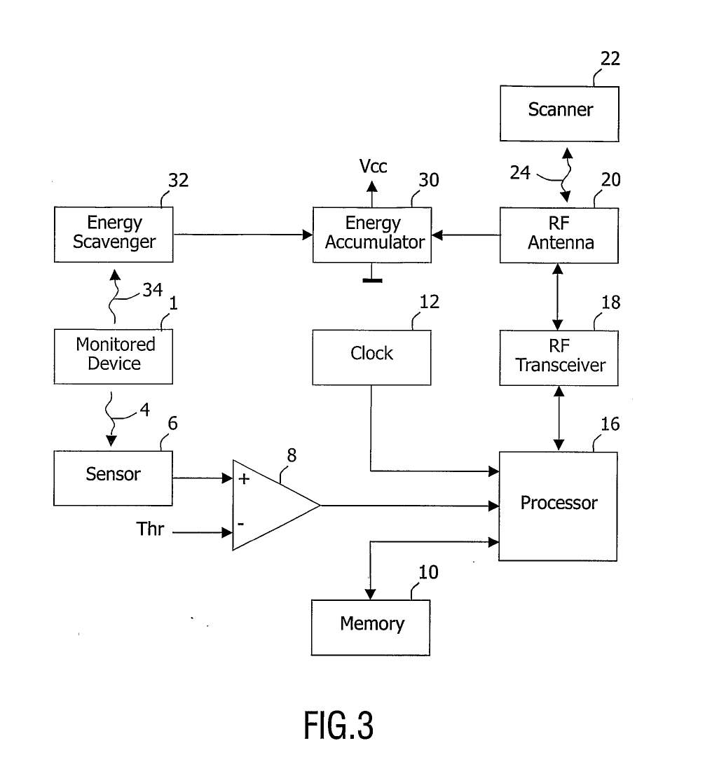

The system shown in FIG. 3 differs from the system shown in FIG. 2 by that the sensing apparatus 6 to 12 and 18 to 22 further comprises an energy accumulator 30 and an energy scavenger 32. The energy accumulator 30 may comprise a capacitor or a battery which can be charged through rectifiers (e.g. diodes; not shown) by the RF antenna 22 and/or the energy scavenger 32. The energy accumulator provides a supply voltage Vcc for the sensing apparatus, in particular, though not shown, from the node of said rectifiers.

The energy scavenger 32 is arranged to receive some kind of energy which is emitted by the monitored device 1, as indicated by the wavy arrow 34, such as heat (by a thermo-electric generator), light (by a solar cell), vibration (by a piezo-electric generator), magnetic field, electrical field and electrical voltage or current. The energy scavenger transforms the energy received from the monitored device 1 to therewith charge the energy accumulator 30. Accordingly, the sensing apparatus 6 to 12, 18 to 20, 30, 32 is self-sustained.

The energy scavenger can be arranged also to receive energy from a different source than the monitored device 1, or from both. For example, the energy scavenger can be arranged to receive and transform solar energy for charging the energy accumulator 30.

Under circumstances the energy received by the energy scavenger 32 is too small to keep the energy level or voltage Vcc of the energy accumulator at a sufficient level for supplying the sensing apparatus. In such a case, scanner 22 will not receive a proper response from the sensing apparatus upon its transmission of said demand for providing the accumulated measured time value stored in memory 10. Preferably, scanner 22 is arranged to detect such condition and to repeat its transmission of said demand by using a higher energy level than before. Then, the higher energy level of the transmission can be sufficient to charge the energy accumulator to a level which is sufficient to supply the sensing apparatus. If the scanner 22 does not receive a proper response still, it may repeat its transmission of the demand by using an even higher energy level than before, and so on. If the scanner does receive a proper response it may store the value of energy level and it may retrieve the stored energy level value for use with future transmissions for accessing the associated monitored device 1.

Under circumstances the sensor 6 and the energy scavenger 32 may be the same component. Examples thereof are a solar cell for sensing operation of a light source, and a vibration sensor for sensing the operation of a machine.

The sensing apparatus may be manufactured with most of its components, its sensor 6 inclusive, integrated in a single silicon substrate. Preferably the sensing apparatus is implemented as a tag, such as a flat self-adhesive tag, which can be adhered to the monitored device 1 or to a part thereof. For example, it can be adhered to a light source or to an armature of a lighting device.

It is observed that, within the meaning of the invention, any number of different entities or properties of the device 1 may be monitored simultaneously. In addition, a value of a monitored entity being below or beyond a threshold value can be considered as an on time of an operation or an event of the device. This allows the recording of data of the operation history of several properties of the device and thus of the device 1 general. In turn, this allows to design and apply a sophisticated maintenance scheme for such a device 1 and groups of devices.

It is also observed that data about an entity or about several entities of operation of the device 1, obtained as described, may be used to generate a feedback signal for a control apparatus which controls the device 1.

It is noted that the scope of the invention is not restricted to the embodiments and examples as described and those shown in the drawings, but that it is defined by the appended claims only.

1. A method for monitoring a duration time of an operation of a device (1), comprising:
a) detecting an on state of said operation;
b) measuring a duration time for each detected on state of said operation;
c) accumulating measured duration times to an accumulated time of operation;
d) storing said accumulated time of operation; and
e) and further processing the stored accumulated time of operation;
characterized in that, the on state of said operation is detected by monitoring an entity of which a change is induced by said operation of the device.

2. Method according to claim 1, characterized in that, the monitored entity is a property of the device.

3. Method according to claim 1, characterized in that, the monitored entity is a property of a retainer for the device.

4. Method according to claim 1, characterized in that, the monitored entity is a property of a medium contained in the device.

5. Method according to claim 1, characterized in that, the monitored entity is sensed through contact of a surface of the device.

6. Method according to claim 1, characterized in that, the monitored entity is sensed through contact of a surface of a retainer for the device.

7. Method according to claim 1, characterized in that, the monitored entity is an entity from a group which comprises heat, movement, flow of a medium contained in the device, pressure, an electrical entity, sound, electrical field and magnetic field, light, radiation.

8. Method according to claim 1, characterized in that, the stored accumulated time of operation is retrieved from its storage by wireless communication on demand from a remote scanner, and the represented accumulated time of operation is the accumulated time of operation retrieved through said scanner.

9. Method according to claim 1, characterized in that, energy for applying the method is scavenged from energy which is generated by the device when said operation is switched on.

10. Method according to claim 9, characterized in that, energy for applying the method is scavenged from energy of the monitored entity.

11. Method according to claim 7, characterized in that, energy for applying the method is scavenged from energy of the wireless communication signal transmitted by the scanner.

12. Method according to claim 11, characterized in that, when the scanner does not, on its demand, acquire the stored accumulated time of operation, the scanner repeats its demand by transmitting a more powerful communication signal.

13. Method according to claim 1, characterized in that, energy for applying the method is scavenged from energy which is generated by a source which is independent from applying the method.

14. Method according to claim 9, characterized in that, the scavenged energy is accumulated for later use for applying the method.

15. Method according to claim 1, characterized in that, the further processing of the stored accumulated time of operation comprises generating a feedback signal while using the stored accumulated time of operation, and supplying the feedback signal to a control apparatus which controls the operation of the device.

16. An apparatus for monitoring a duration time of an operation of a device (1), said apparatus comprising a sensor (6) for detecting an occurrence of said operation, a clock generator (12) for generating clock pulses, a counter for counting clock pulses upon detecting said occurrence, a memory (10) for storing an accumulated count of counted clock pulses, an input/output circuit 14; 18, 22) for entering a demand for retrieving the accumulated count from said memory and for outputting the retrieved accumulated count, and a processor (16) which is arranged and connected to provide said counting of clock pulses, storing said accumulated count, and retrieving and outputting the accumulated count upon entering the demand, characterized in that, the sensor (6) is arranged to detect an entity of which a change is induced by said operation of the device (1).

17. Apparatus according to claim 16, characterized in that, it comprises an energy accumulator (30) and an energy scavenger (32), the scavenger scavenging energy from the environment of the apparatus, and the scavenger transfers the scavenged energy to the accumulator, whereby the accumulator supplies energy consuming components of the apparatus.

18. Apparatus according to claim 16, characterized in that, it AY comprises a tag.

19. A System for monitoring a duration time of operation of a device (1), comprising a first apparatus of a sensor (6) for sensing an occurrence of said operation, means (12, 16) for measuring a duration time of said occurrence, accumulating measured duration times to provide an accumulated time, storing the accumulated on time and outputting the stored accumulated on time on demand from the outside of the first apparatus, characterized in that, the sensor is arranged to detect an entity of which a change is induced by said operation of the device, and further comprising a second apparatus (22), the first and second apparatuses containing wireless communication circuits, which are arranged to provide said demand from the second apparatus to the first apparatus and to provide the stored accumulated duration time from the first apparatus to the second apparatus upon receiving the demand by the first apparatus.

20. System according to claim 19, characterized in that, the first apparatus comprises an energy accumulator (30) and an energy scavenger (32), the scavenger scavenging energy from a transmission of energy by the second apparatus, and the scavenger transfers the scavenged energy to the accumulator, whereby the accumulator supplies energy consuming components of the first apparatus.

21. System according to claim 19, characterized in that, the second apparatus is arranged to repeat a transmission with a higher energy level than before upon a failing of receiving a response upon the transmission of said demand by the second apparatus.

22. System according to claim 19, characterized in that, the first apparatus comprises a tag.
